(19) United States
(12) Patent Application Publication
(10) Pub. No.: US 2004/0138972 A1
(43) Pub. Date: Jul. 15, 2004

(54) Method of disposing of artwork for financially benefiting charitable organizations

(76) Inventor: Michael Mendelsohn, Hastings-on-Hudson, NY (US)

Correspondence Address: Charles R. Macedo, Esq., Amster, Rothstein & Ebenstein, 90 Park Avenue, New York, NY, 10016, US

(21) Appl. No.: 10/342,903

(22) Filed: Jan. 15, 2003

(51) Int. Cl. G06F 17/60

(52) U.S. Cl. 705/35

(57) ABSTRACT

The present invention generally relates to a system and method for disposing of an art collector's artwork in a manner which financially benefits charitable organizations. More particularly, the system and method of the present invention combines a variety of financing techniques and strategies create endowment funds for charitable organizations. In particular, the method of the present invention combines the concepts of donating art to related-use organization, fractional gifting of the artwork, gifting of related charitable tax deductions, and gifting of life insurance and financed premiums to other charitable organizations. The method of the present invention creates a “dual legacy”, assisting many charities in establishing present and future endowment funding.

### FIELD OF THE INVENTION

The present invention generally relates to a method for disposing of an art collector's artwork in a manner which financially benefits charitable organizations. More particularly, the system and method of the present invention combines a variety of financing techniques and strategies to create endowment funds for charitable organizations. In particular, the method of the present invention combines the concepts of donating art to related-use organizations, fractional gifting of the artwork, gifting of related charitable tax deductions, and gifting of life insurance and financed premiums to charitable organizations. The present invention also relates to gifting tax savings to charitable organizations which may be used as a financed premium for future endowment. The method of the present invention creates a “dual legacy”, assisting many charities in establishing present and future endowment funding.

### BACKGROUND OF THE INVENTION

Fractional gifting is a gift of a percentage of the owner's interest in art work which results in tax savings to the donor while providing art work for a limited period of time to museums. The process of fractional gifting is well known and typically involves the following steps: the donor locates a museum to donate the art work; the donor prepares a deed of gift or similar document; the donor specifies what is to be donated to the museum; the donor specifies the percentage of the owner's interest in the art that is to be donated to the museum; and the donor establishes the terms and conditions under which the art work is being offered to the museum. Thereafter, the museum executes an acceptance of the offer. An important part of fractional gifting is the agreement that the entire work will eventually be given permanently to the museum. In this regard, a percentage of the owner's interest in the artwork is agreed upon each time a gift is made (i.e., 10% per year for 10 years). The donor may amend his/her will to allow any ungifted percentage to go to the museum at the time of his/her death. Various provisions of the tax code and tax regulations are of particular interest here, including, 26 U.S.C. § 170 and 26 C.F.R. § 1.170A currently governing whole and fractional interest gifts of art to museums. Many other tax provisions may also apply in some instances, including, but not limited to 26 U.S.C. §§ 2031, 2055, 2056, 2503, 2512, 2522, 2523, etc., to name a few.

When an art collector makes a fractional gift of an artwork (e.g., a 10 percent interest), the museum or other “related-use organization” (such as hospitals, universities, art museums, religious institutions, etc., or other tax-exempt non-profit organization as defined by 26 U.S.C. §501 (c) (3) of the current tax code or a comparable provision in future tax codes who use the gifted artwork) can display the gifted artwork and/or use the artwork as a study tool. Thus, in the example where a 10% interest in an artwork is gifted to a related-use organization, such organization is entitled to the work for 10 percent of the year (approximately 37 days) and the collector retains the rights in the artwork for the remainder of the year. Many museums rely on fractional gifting to build their art collections. By making a fractional gift, the collector is entitled to a tax credit for simply giving the museum the right to display the artwork. In this regard, under the current U.S. Tax Code, when a collector donates a work of art to a museum, the donor is generally entitled to deduct the fair market value of that gift in computing the donor's taxable income. Under the current tax code, deductions for contributions of personal property are limited to 30% of the donor's adjusted gross income. Unused deductions may be carried forward and used in five succeeding years. In the past, donors have used the tax deduction received for fractional gifts of artwork for a variety of self-beneficial purposes. For example, donors have used the tax deduction to further the donor's personal well being, to reduce gift taxes to children, etc.

Art collectors often fail to account for artwork in their estate plan or their will. Where the collector's heirs do not want or cannot reasonably divide the art collection (due to both valuation and sentimental reasons), they will typically auction off the entire art collection upon the collector's death. Other heirs may wish to auction off the entire art collection to cover the cost of the estate taxes owed to the federal government. When all of the deceased collector's artwork is auctioned at once, the artwork frequently sells for an amount which is significantly less than the artwork's fair market value. Additionally, auction fees are typically taken from the sales of the artwork. Moreover, uncertainties of the auction world may have artwork sold for less than its appraised or insured value. Also some artwork that does not sell (e.g., because it fails to meet reserve price established by an auction house) remains in the estate and is taxed as part of the estate with no offsetting income to assist in the payment of such taxes. For example, in November, 2002, the sales at some leading auction houses for middle market artwork were slow, with a high percentage (approximately 25-30%) of art going unsold. Furthermore, the proceeds from the auctioned artwork are subject to estate taxes, which can be approximately as much as 50% of the proceeds from the auction, as governed by the tax code (currently 26 U.S.C. 2001). As a result of these events, the art collector's heirs will often take home only a fraction of the value of the artwork (e.g., 30% of the artwork's fair market value) that they would have been otherwise entitled to had the art collector made appropriate and effective estate plans. Due to such poor estate planning, heirs can lose more than 70% of the value of an art collection.

Other collectors have disposed of their artwork through different methods which have also precluded the collector or their families from realizing the fair market value of the disposed of art. In this regard, some art collectors have gifted their artwork during their lifetime to children, and as a result, were subject to gift taxes when the artwork was valued over the maximum annual or lifetime gift exemptions, which is currently $12,000 per donor per recipient annually and $1 million per donor over the donor's lifetime for the present tax year. This imposed gift tax has deterred many from gifting their valuable art collection in this manner. Other collectors have sold their art collections during their lifetime, but have been subject to paying capital gain taxes (currently, as much as 28% of the sale price). Even worse, the cash obtained from such sale could also be subjected to estate taxes upon the collector's death, thereby imposing a second tax of as much as 50% (under the current law) of the 82% of the artwork's value obtained by the lifetime sales leaving the collectors heirs with only 41% of the value of the artwork as an inheritance at best, even assuming the collector obtained fair market value for the artwork during the lifetime sale. As should be apparent, these prior methods of disposing of artwork are ineffective means for realizing the fair market value of an art collection.

As a result of these problems, both art collectors and their heirs will only receive a small fraction of the value of the artwork when it is disposed of under the above traditional methods. Thus, there has been a long felt need for a method which makes more productive and valuable use of artwork being disposed of by a collector.

Other donors donate cash to charitable organizations to reduce the taxable portion of their estate. However, when these same donors are art collectors, their art collections are typically not disposed of in a manner which is advantageous to the estate as discussed above. Thus, there is a need to provide a method for art collectors to dispose of artwork in a manner which maximizes the value of the art collection while at the same time reduces the taxable income on their estate.

The creation and growth of an endowment fund(s) is critical to most charitable organizations to help achieve such organizations' mission. In the past, charitable organizations have conducted fundraising activities through conventional methods to build endowment funds, including, for example, collecting donations by hand, mail and telephone solicitations, inheritance, etc. When the charitable organization is a qualified not-for-profit organization under 26 U.S.C. §501 (c) (3) (or a comparable provision of future tax codes), donors are entitled to deduct the value of the donation made, subject to certain caps and/or conditions imposed by the tax code. Although these prior fundraising methods have been somewhat useful, it is a stark reality that they have fallen far short of meeting the financial needs and goals of such charitable organizations. In this regard, for many years, art related and/or charitable organizations have suffered from mild to severe cash shortages. As a result, it has become increasingly difficult for such organizations to meet their mission, let alone cover their operating costs. Thus, there is a long felt need to improve upon and/or supplement these prior fundraising methods to assist such organizations in realizing their goals and continuing their operations.

While the prior art is of interest, the known methods of the prior art present several limitations which the present invention seeks to overcome.

In particular, it is an object of the present invention to provide an effective and valuable method for disposing of artwork in an estate.

It is another object of the present invention to seek donations from art collectors who receive a tax deduction for making fractional gifts.

It is a further object of the present invention to provide a method for providing funding towards an endowment that will assist charitable organizations in realizing their mission.

It is another object of the present invention to provide a method for creating an endowment for a charitable organization by investing charitable tax benefits donated by art collectors, who obtain such tax benefit through fractional gifting of art work to the charitable organization or other “related use organizations”.

It is a further object of the present invention to provide benefactors with a method for using portions of their income, which would otherwise be taxable, for philanthropic purposes.

It is another object of the present invention to provide art collectors with a method for disposing of works of art in a charitable manner.

It is another object of the present invention to provide a method for creating an endowment fund for charitable organizations through the use of monetary donations and life insurance proceeds.

It is a further object of the present invention to provide a method for financing life insurance policies used to fund endowment funds of charitable organizations.

It is another object of the present invention to solve shortcomings of the prior art.

Further objects and advantages will become apparent from a consideration of the ensuing description and drawings.

### SUMMARY OF THE INVENTION

It has now been found that the above and related objects of the present invention are obtained in the form of a method a method for financing an endowment fund for at least one charitable organization comprising the steps of locating at least one charitable organization desiring to establish and/or enhance at least one endowment fund; soliciting at least one art collector to donate art work to a related use organization. Additionally, the method of present invention includes the steps of: soliciting the art collector to donate a fractional portion of at least one work of art to the related use organization; soliciting from the art collector a monetary donation to an endowment fund of said charitable organization, the monetary donation comprising at least a portion of a charitable tax benefit received by said art collector for making said fractional donation of said artwork to said related use organization.

In another embodiment of the method of the present invention, an endowment program for at least one charitable organization is created and maintained by: establishing at least one endowment fund; receiving a donation of fractional portion of at least one work of art from an art collector; receiving from the art collector a monetary donation which comprises at least a portion of a charitable tax benefit received by the art collector for making said fractional donation of the artwork; and allocating at least a portion of the monetary donation to said endowment fund.

In yet another embodiment of the present invention, a method for creating and maintaining an endowment fund is performed by: receiving a first monetary donation from at least one benefactor; obtaining at least one insurance policy covering the life of at least one individual, wherein a premium for the life insurance policy corresponds to the amount of money donated by the at least one benefactor; and designating a charitable organization as the owner of and beneficiary of all life insurance proceeds on the life insurance policy.

In another embodiment of the present invention, a method is provided for financing an endowment fund of at least one charitable organization by: soliciting a first monetary donation from at least one benefactor to be placed in the endowment fund; identifying at least one insurance policy covering the life of at least one individual, wherein a premium for the life insurance policy corresponds to the amount of money solicited from the at least one benefactor; and soliciting the individual to assign all rights to said life insurance policy to the endowment.

### DETAILED DESCRIPTION OF THE PREFERRED EMBODIMENT

The present invention generally relates to a method for disposing of an art collector's artwork in a manner which financially benefits both charitable organizations as well as the collector's heirs. More particularly, the system and method of the present invention combine in a novel and unobvious manner a variety of financing techniques and strategies to create endowment funds for charitable organizations. In particular, the method of the present invention combines the concepts of donating art to related-use organizations, fractional gifting of the artwork, gifting of related charitable tax deductions, and gifting of life insurance and financed premiums to charitable organizations. More particularly, the method of the present invention includes two separate, but related aspects: (1) a charitable art legacy in which tax benefits obtained through partial gifting of art are donated to a not-for-profit Section 501(c) (3) charitable organization and/or used to create an endowment fund for such organization; and (2) a financed endowment fund created for the benefit of charitable organizations which is funded by monetary donations from benefactors as well by proceeds obtained from insurance policies owned by the charitable organization. Each of these aspects is described below.

The charitable art legacy program is generally created for benefactors who collect art. The purpose of the program is to assist charitable organizations in reaching their future “mission”. For example, one charitable organization, known as “HeartSong” has a mission of providing art and music therapy for children and families with special needs. A great deal of funding and support is needed for this charitable organization to achieve these goals.

Accordingly, the charitable art legacy program provides funding to these organizations by having its benefactors gift work(s) of art from their collection to an appropriate museum, Section 501(c)(3) related-use organization and/or other charitable organization. In a preferred embodiment, the program locates such museums, Section 501(c) (3) related-use organizations and/or other charitable organizations and the artwork is preferably provided to them as a fractional gift. By making a gift in this manner, a charitable tax benefit is made available to the donor under the U.S. Tax Code as described herein. The donor, in turn, donates this tax benefit to the chosen charitable organization (e.g., HeartSong). In this regard, the charitable art legacy program can assist the donor in structuring the charitable tax benefit as a gift to the charitable organization. This gift can be placed in an endowment fund established by the charitable organization and be used toward achieving the mission of such organization. For example, in the case of HeartSong, the charitable tax benefit gift can be donated to a HeartSong art and music endowment fund for the future. Additionally, the money placed in the endowment fund can be invested in income earning accounts (e.g., annuities, stocks, bonds, etc.).

In one embodiment of the charitable art legacy program, the program includes 50 benefactors/collectors who have agreed to provide fractional gifts of their artwork from their personal collections for the benefit of a charitable organization. The program identifies structures and completes gifts of art to appropriate museums and/or relate use space charities. In this embodiment, if the appraised value of each gift is, for example, is $10,000, then the program creates a charitable tax benefit for each benefactor of $4,000, as permitted under the current tax code. This charitable tax benefit will be gifted to the specified charitable organization in connection with achieving their mission. Thus, a total of $200,000 in this embodiment (i.e., 50 benefactors×$4000/benefactor) is provided to an endowment fund of the charitable organization. If this program continues for 10 years under the same conditions, the endowment could be set up so as to divide the $200,000 gift as follows: $100,000 for current needs and $100,000 for future endowment. Thus, over ten years, $1,000,000 (i.e., $100,000/year over 10 years) would be provided for current needs and $25,000,000 for the endowment (e.g., this amount is based on estimated interest and other income earned on the $100,000/year allocated for the endowment fund over a ten year period).

Both the benefactors and charitable organizations benefit from this method. In this regard, benefactors are able to use portions of their income which would otherwise be taxable for philanthropic purposes. Additionally, benefactors are provided with a means for disposing of works of art which may not currently fit the collector's vision without having to sell at reduced prices. Furthermore, benefactors gain name recognition and satisfaction in contributing to the financial well being of charitable organizations. Similarly, charitable organizations benefit from the method of the present invention since the charitable tax benefit gifted to it will help to ensure that the charitable organization's mission will be achieved well into the future. Furthermore, even if tax laws regarding these types of gifts change in the future, the method of the present invention provides the charitable organization funding for both the present and future each time such gift is made under the current tax rules. Moreover, the method of the present invention ensures that funding is in place to assist the charitable organization in developing current and future programs.

Having described the charitable art legacy program, the financed endowment program is now described. Generally speaking, a charitable organization establishes a “Financed Endowment Program” in which an endowment fund is created and funded by income earned on donations received from benefactors. As will be seen below, monetary donations received from benefactors are invested in income earning accounts, and in an ideal market, continue to grow over time. Additionally, to supplement the endowment fund, life insurance policies can be taken out on various individuals, such as benefactors, board members and/or trustees of the charitable organization, the proceeds of which will be placed into the endowment fund at the appropriate time. Accordingly, the income earned on the funds in the separate account, combined with the proceeds received from the life insurance policies, will enhance the overall value of the endowment fund. As a result, the financed endowment fund will assist charitable organizations in continuing their mission into the future. Additionally, this program allows donors to redirect some of their wealth and/or extra income into a long term plan for the benefit of a charitable organization, while at the same time receiving tax benefits in doing so. The method for investing donations and financing life insurance policies is now described.

In particular, a charitable institution receives a monetary donation from a benefactor. Preferably, the benefactor donates a specific amount of money to the charitable institution each year for a predetermined number of years. In one embodiment, a benefactor(s) donates $102,075 per year to a charitable, not-for-profit organization for a period of ten years. By donating this amount, the benefactor receives an IRS approved charitable deduction, which at the benefactor's option, may also be donated to the charitable organization. Presently, Section 170 of the U.S. tax code provides for such deduction. The charitable organization retains such donations in a separate account owned by the charitable organization to maintain a long term endowment. These funds should be invested so as to earn positive annual returns and could be invested, for example, in mutual funds, stocks, bonds, real estate, etc.

To supplement the income earned in the separate account, the charitable organization may obtain life insurance policies on various benefactors, trustees, directors and/or key employees. The insurance premium for each policy should correspond directly to the amount of money donated by the benefactor(s). To pay for the insurance premium, the charitable organization may borrow money from a lender. In one embodiment, the lender is A.I. Credit and the funds are loaned at London Interbank Overnight Rates (“LIBOR”) Plus. The lending institution lends these funds to the charitable organization under “their innovative ‘Capital Maximization Strategy Program’”. These borrowed funds are used to pay the full insurance premium. The loan is secured by the cash values of the policy. Additionally, the loan may be secured by the Endowment Fund Balance and life insurance policy cash values itself. Furthermore, the life insurance policy should be designed with a specific rider guaranteeing full repayment of the loan, which will be taken from the proceeds of the policy at the person's time of death. The interest and principal payable on the loan is paid for using income earned on the benefactor's gifts maintained in the separate account. The charitable organization is designated as the owner of the insurance policy and is designated as the beneficiary for all proceeds earned from the policy. Preferably, all insurance policies have an increasing death benefit which guarantees repayment of the loan. When the person named in the policy dies, the proceeds from the policy are used to pay off the loan which funded the policy, and the remaining proceeds are added to the separate account. As a result, the endowment fund in the separate account continues to grow over time.

Table 1 shows one embodiment of the Financial Endowment Program.

TABLE 1

| | | | | | | | B | |
|---|---|---|---|---|---|---|---|---|
| | | | D | F | E | | Endowment | G |
| | Benefactors | | Annual | Total | 7.5% | C | Fund | Cash |
| | | After-Tax | Premium | Premium | Annual | Insurance | Balance | Surrender |
| Year | Donation | Outlay | Loan | Loan | Interest | Proceeds | @ 10% | Value |
| 1 | (102,075) | (61,245) | 102,075 | 102,075 | (7,656) | | 103,861 | |
| 2 | (102,075) | (61,245) | 102,075 | 204,150 | (15,311) | | 209,688 | 50,502 |
| 3 | (102,075) | (61,245) | 102,075 | 306,225 | (22,967) | | 317,675 | 158,540 |
| 4 | (102,075) | (61,245) | 102,075 | 408,300 | (30,623) | | 428,041 | 270,657 |
| 5 | (102,075) | (61,245) | 102,075 | 510,375 | (38,278) | | 541,021 | 386,114 |
| 6 | (102,075) | (61,245) | 102,075 | 612,450 | (45,934) | | 656,879 | 518,974 |
| 7 | (102,075) | (61,245) | 102,075 | 714,525 | (53,589) | | 775,901 | 661,414 |
| 8 | (102,075) | (61,245) | 102,075 | 816,600 | (61,245) | | 898,404 | 815,398 |
| 9 | (102,075) | (61,245) | 102,075 | 918,675 | (68,901) | | 1,024,736 | 978,500 |
| 10 | (102,075) | (61,245) | 102,075 | 1,020,750 | (76,556) | | 1,155,280 | 1,148,947 |
| 11 | 0 | 0 | 0 | 1,020,750 | (76,556) | | 1,186,596 | 1,226,017 |
| 12 | 0 | 0 | 0 | 1,020,750 | (76,556) | | 1,221,044 | 1,304,343 |
| 13 | 0 | 0 | 0 | 1,020,750 | (76,556) | | 1,258,937 | 1,383,464 |
| 14 | 0 | 0 | 0 | 1,020,750 | (76,556) | | 1,300,618 | 1,463,105 |
| 15 | 0 | 0 | 0 | 0 | 0 | 279,617 | 1,738,259 | 1,542,770 |
| 16 | 0 | 0 | 0 | 0 | 0 | | 1,912,085 | |
| 17 | 0 | 0 | 0 | 0 | 0 | | 2,103,293 | |
| 18 | 0 | 0 | 0 | 0 | 0 | | 2,313,623 | |
| 19 | 0 | 0 | 0 | 0 | 0 | | 2,544,985 | |
| 20 | 0 | 0 | 0 | 0 | 0 | 1,252,729 | 4,177,485 | |
| 21 | 0 | 0 | 0 | 0 | 0 | | 4,595,234 | |
| 22 | 0 | 0 | 0 | 0 | 0 | | 5,054,757 | |
| 23 | 0 | 0 | 0 | 0 | 0 | | 5,560,233 | |
| 24 | 0 | 0 | 0 | 0 | 0 | | 6,116,256 | |
| 25 | 0 | 0 | 0 | 0 | 0 | 2,398,144 | 9,365,840 | |
| 26 | 0 | 0 | 0 | 0 | 0 | | 10,302,424 | |
| 27 | 0 | 0 | 0 | 0 | 0 | | 11,332,667 | |
| 28 | 0 | 0 | 0 | 0 | 0 | | 12,465,933 | |
| 29 | 0 | 0 | 0 | 0 | 0 | | 13,712,527 | |
| 30 | 0 | 0 | 0 | 0 | 0 | 1,150,348 | 16,349,162 | |
| 31 | 0 | 0 | 0 | 0 | 0 | | 17,984,078 | |
| 32 | 0 | 0 | 0 | 0 | 0 | | 19,782,486 | |
| 33 | 0 | 0 | 0 | 0 | 0 | | 21,760,735 | |
| 34 | 0 | 0 | 0 | 0 | 0 | | 23,936,808 | |
| 35 | 0 | 0 | 0 | 0 | 0 | | 26,330,489 | |
| Total | (1,020,750) | (612,450) | | | | | | |

Referring to Table 1, an example is shown where five benefactors collectively donate a total of $102,075/year over a ten year period. Their after-tax outlay is $61,245 for each year (this amount is calculated under the assumption that a benefactor's tax bracket is approximately 40%). Referring to Column D, the “Annual Premium Loan” represents a loan taken from a lender to finance the insurance policy taken out. The Annual Premium Loan for each year corresponds to the Donation received from the benefactor in that year. Referring to Column F, the “Total Premium Loan” represents the total amount owed on loans used to finance insurance premiums that were taken by the charitable organization. Column E represents the amount paid in interest on such loans based on an actual rates much lower 7.5% annual interest rate. Column C represents the insurance proceeds received by the charitable organization at the time of death for each insured individual. In this example, 5 individuals are insured, wherein one individual is a 55 year old male, two are 60 year old males, one is a 65 year old male and one is a 70 year old male, all with an assumed death age of 85. Column B represents the Endowment Fund Balance for each year based on earnings at actual rates much lower 10% growth. Column G represents (i.e., the “Cash Surrender Value”) total cash value of all 5 policies, which is used as collateral for loan. As can be seen, if all conditions assumed in this example are met, $1,020,760 donated over a ten year period will generate a total of over $26 million in the Endowment Fund over a 35 year period. The charitable organization will also be in a position to solicit other donors by explaining the fact that it has a future endowment fund estimated at $26 million.

Now that the preferred embodiments of the present invention have been shown and described in detail, various modifications and improvements thereon will become readily apparent to those skilled in the art. For example, the above description makes reference to various provisions of the U.S. Tax Code and Regulations. However, the present invention is not limited to these provisions, as one would expect amendments and/or revocations of these provisions in the future. Furthermore, the present invention is not limited to the provisions of the U.S. Tax Code and Provisions, but may also apply to appropriate state, local or even foreign tax rules and regulations. Accordingly, the spirit and scope of the present invention is to be construed broadly and limited only by the appended claims and not by the foregoing specification.

What is claimed is:

1. A method for financing an endowment fund for at least one charitable organization comprising the steps of:
locating at least one charitable organization desiring to establish and/or enhance at least one endowment fund;
soliciting at least one art collector to donate art work to a related use organization;
soliciting said art collector to donate a fractional portion of at least one work of art to said related use organization;
soliciting from said art collector a monetary donation to an endowment fund of said charitable organization, said monetary donation comprising at least a portion of a charitable tax benefit received by said art collector for making said fractional donation of said artwork to said related use organization.

2. The method of claim 1, wherein said related use organization is the same organization as said charitable organization.

3. The method of claim 1, comprising the further step of: identifying investments in which said endowment fund can use to potentially earn income from said monetary donation.

4. A method for creating and maintaining an endowment program for at least one charitable organization comprising the steps of:
establishing at least one endowment fund;
receiving a donation of fractional portion of at least one work of art from an art collector;
receiving from said art collector a monetary donation which comprises at least a portion of a charitable tax benefit received by said art collector for making said fractional donation of said artwork; and
allocating at least a portion of said monetary donation to said endowment fund.

5. The method of claim 4, further comprising the step of assisting said art collector in structuring said charitable tax benefit received by said art collector as a gift to said charitable organization.

6. The method of claim 4, further comprising the step of investing said donation allocated for said endowment fund in at least one investment have potential for earning income.

7. The method of claim 6, where said at least one investment comprises one or more of stocks, mutual funds, bonds and real estate.

8. The method of claim 4, further comprising the step of assisting said art collector in amending said collector's will to bequeath the entire art work to said related use organization upon said collector's death.

9. A method for creating and maintaining an endowment fund comprising:
receiving a first monetary donation from at least one benefactor;
obtaining at least one insurance policy covering the life of at least one individual, wherein a premium for said life insurance policy corresponds to the amount of money donated by said at least one benefactor; and
designating a charitable organization as the owner of and beneficiary of all life insurance proceeds on said life insurance policy.

10. The method of claim 9, further comprising the step of establishing an endowment fund.

11. The method of claim 9, further comprising the step of receiving a second monetary donation-from said benefactor, said second monetary donation comprising a tax deduction received by said benefactor for making said first monetary donation.

12. The method of claim 11, further comprising the step of investing said first and second monetary donations in income earning accounts.

13. The method of claim 9, further comprising the step of obtaining a loan from a lending institution to pay for the costs of said premium.

14. The method of claim 13, securing said loan with the cash value of said insurance policy and/or said endowment fund's cash value.

15. The method of claim 14, further comprising the step of guaranteeing full repayment of said loan with the proceeds taken from said life insurance policy upon the death of said individual.

16. The method of claim 15, further comprising the step of paying off said loan upon the death of said insured individual.

17. The method of claim 16, further comprising the step of placing any remaining proceeds, after repayment of said loan, in a separate income earning account.

18. A method for financing an endowment fund of at least one charitable organization comprising the steps of:
soliciting a first monetary donation from at least one benefactor to be placed in said endowment fund;
identifying at least one insurance policy covering the life of at least one individual, wherein a premium for said life insurance policy corresponds to the amount of money solicited from said at least one benefactor; and
soliciting said individual to assign all rights to said life insurance policy to the endowment.

19. The method of claim 18, further comprising the step of soliciting from said benefactor a second monetary donation, said second monetary donation comprising a tax deduction received by said benefactor for making said first monetary donation.

20. The method of claim 19, further comprising the step of investing said first and second monetary donations in income earning accounts.

21. The method of claim 9, further comprising the step assisting said charitable organization in obtaining a loan from a lending institution to pay for the costs of said premium.

22. The method of claim 21, further comprising the step of advising said charitable organization to secure said loan with the cash value of said insurance policy and/or said endowment fund's cash value.

23. The method of claim 22, further comprising the step of advising said charitable organization to guarantee full repayment of said loan with the proceeds taken from said life insurance policy upon the death of said individual.

24. The method of claim 23, further comprising the step of advising said charitable organization to pay off said loan upon the death of said insured individual.

25. The method of claim 16, further comprising the step of advising said charitable organization to place any remaining proceeds, after repayment of said loan, in a separate income earning account.
